(19) United States
(12) Patent Application Publication
(10) Pub. No.: US 2018/0173356 A1
(43) Pub. Date: Jun. 21, 2018

(54) FORCE SENSOR AND FORCE TOUCH PANEL

(71) Applicant: Wuhan China Star Optoelectronics Technology Co. Ltd., Wuhan City (CN)

(72) Inventors: Yaoli Huang, Wuhan City (CN); Hongsen Zhang, Wuhan City (CN); Xinglong He, Wuhan City (CN)

(21) Appl. No.: 15/121,036

(22) PCT Filed: Jun. 27, 2016
(86) PCT No.: PCT/CN2016/087323

§ 371 Date: Aug. 24, 2016

(30) Foreign Application Priority Data
May 26, 2016 (CN) 201610361279.5

(51) Int. Cl. G06F 3/041; G06F 3/044

(52) U.S. Cl. CPC G06F 3/0414; G06F 2203/04101; G06F 3/041; G06F 3/044

(57) ABSTRACT

The present invention provides a force sensor and a force touch panel. The force sensor includes a backing (1), a plurality of sensor units (2) arranged on the backing (1), a plurality of conductive lines (4) arranged on the backing (1) and respectively corresponding to the plurality of sensor units (2), and a circuit board (3) arranged at one side of the backing (1). The plurality of sensor units (2) is arranged on the backing (1) in a diverging form from a central position of the backing (1) toward a periphery of the backing (1). Surface areas of the sensor units (2) are increased from the central position of the backing (1) toward the periphery of the backing (1), so that, compared to the prior art, it is possible to ensure consistent detection sensitivity through various areas of the surface of the force sensor and improve an effect of force touch experience of a user. The force touch panel of the present invention helps ensure consistent response sensitivity through various areas of a surface of the force touch panel so as to improve an effect of force touch experience of a user.

### BACKGROUND OF THE INVENTION

### 1. Field of the Invention

The present invention relates to the field of touch display technology, and in particular to a force sensor and a force touch panel.

### 2. The Related Arts

The fast progress of electronic products, such as smart phones and tablet computers, brings increasing enlargement of the sizes of display screens and operation modes are being changed from the traditional ways of pushbutton based operations to touch based operations. Accompanying with this is the quick progress of force touch panels.

The force touch panels are structured to realize detection of force touch based on variations of forces detected by a force sensor to indicate deformations caused by a user's fingers pressing down a surface of a touch panel of a smart electronic product. According to the ways that are adopted to detect forces, the force touch panels can be classified in three categories, which are piezoelectric mode, resistive mode, and capacitive mode. The resistive touch panel has a simple design and the lowest cost, but the piezoelectric mode suffers physical constraints, such as low light transmission rate and a large detection area that has a large number of lines imposing a burden to a processor of a smart electronic product, and the resistive touch panel must keep in a conducting condition, which leads to additional power consumption of the smart electronic product, and is easy to get aging and thus affecting the lifespan thereof, all these concluding with a result of being increasingly abandoned. The piezoelectric touch panel achieves touch control by means of piezoelectric driving and the way of driving is similar to the driving of a liquid crystal display panel, but also suffers the same drawbacks of the resistive touch panels, plus being not mature in manufacturing operations thereof, so as not to be widely used.

The capacitive touch panel is generally a mature technique, having a high yield rate and a relatively low cost, so as to be widely used. The capacitive touch panel is generally structured by tightly attaching a force sensor to an intermediate frame or a back side of a liquid crystal display module. As shown in FIG. 1, a conventional force sensor is shown in a schematic view and comprises: a backing 10, a plurality of sensor units 20 arranged on the backing 10, a plurality of conductive lines 40 arranged on the backing 10 and respectively corresponding to the sensor units 20, and a flexible printed circuit (FPC) 30. The plurality of sensor units 20 are connected, via the conductive lines 40 corresponding thereto, to the FPC 30. As shown in FIG. 1, the plurality of sensor units 20 are generally rectangular in shape and have the same area and are arranged in a rectangular array on the backing 10. Such an arrangement may realize detection of force touches, yet due to retention achieved with a module frame of the force touch panel, the same force applied at different sections of the force touch panels would cause different amounts of deformation according to different locations where the force touch is applied, where the amount of deformation at a central zone is relatively large, while that at a peripheral zone is relatively small. This would result in a significant difference between a force variation (variation of capacitance) detected by a sensor unit 20 in the central zone and that detected by a sensor unit 20 in the peripheral zone and of the same size and consequently, the sensitivity of touch of the force touch panel shows relatively poor consistency.

### SUMMARY OF THE INVENTION

An object of the present invention is to provide a force sensor that ensures consistency of detection sensitivity through various areas of the force sensor so as to improve the effect of force touch experience of a user. Another object of the present invention is to provide a force touch panel, which ensures consistency of detection sensitivity through various areas of a surface thereof so as to improve the effect of force touch experience of a user.

To achieve the above objects, the present invention provides a force sensor, which comprises: a backing, a plurality of sensor units arranged on the backing, a plurality of conductive lines arranged on the backing and respectively corresponding to the plurality of sensor units, and a circuit board arranged at one side of the backing;

wherein the sensor units are connected, through the conductive lines corresponding thereto, to the circuit board;

the plurality of sensor units are arranged in a diverging form from a central position of the backing toward a periphery of the backing; and

among the plurality of sensor units, the sensor unit located at the central position of the backing has a smallest surface area and surface areas of the remaining sensor units are increased with distances thereof from the central position of the backing.

The sensor units have a shape of one of square, circle, and regular hexagon.

The backing comprises a flexible polymer film.

The sensor units and the conductive lines are formed of a material comprising silver or indium tin oxides.

The circuit board is a flexible circuit board.

The present invention also provides a force touch panel, which comprises a force sensor;

wherein the force sensor comprises a backing, a plurality of sensor units arranged on the backing, a plurality of conductive lines arranged on the backing and respectively corresponding to the plurality of sensor units, and a circuit board arranged at one side of the backing;

the sensor units are connected, through the conductive lines corresponding thereto, to the circuit board;

the plurality of sensor units are arranged in a diverging form from a central position of the backing toward a periphery of the backing; and

among the plurality of sensor units, the sensor unit located at the central position of the backing has a smallest surface area and surface areas of the remaining sensor units are increased with distances thereof from the central position of the backing.

The sensor units have a shape of one of square, circle, and regular hexagon.

The backing comprises a flexible polymer film.

The sensor units and the conductive lines are formed of a material comprising silver or indium tin oxides.

The circuit board is a flexible circuit board.

The present invention further provides a force sensor, which comprises: a backing, a plurality of sensor units arranged on the backing, a plurality of conductive lines arranged on the backing and respectively corresponding to the plurality of sensor units, and a circuit board arranged at one side of the backing;

wherein the sensor units are connected, through the conductive lines corresponding thereto, to the circuit board;

the plurality of sensor units are arranged in a diverging form from a central position of the backing toward a periphery of the backing; and

among the plurality of sensor units, the sensor unit located at the central position of the backing has a smallest surface area and surface areas of the remaining sensor units are increased with distances thereof from the central position of the backing;

wherein the sensor units have a shape of one of square, circle, and regular hexagon; and

wherein the backing comprises a flexible polymer film.

The efficacy of the present invention is that the present invention provides a force sensor, which comprises a backing, a plurality of sensor units arranged on the backing, a plurality of conductive lines arranged on the backing and respectively corresponding to the plurality of sensor units, and a circuit board arranged at one side of the backing. Positions of the plurality of sensor units on the backing are arranged in a diverging form from a central position of the backing toward a periphery of the backing; and surface areas of the sensor units are arranged to be increased from a central position of the backing toward the periphery of the backing, so that in a condition where forces of the same magnitude are applied thereto, the sensor unit at the central position of the backing of the force sensor and the sensor units at a periphery of the backing would detect substantially the same amount of force variation, whereby, compared to the prior art, it is possible to ensure consistent detection sensitivity through various areas of the surface of the force sensor and improve an effect of force touch experience of a user. The present invention provides a force touch panel, which ensures consistent response sensitivity through various areas of the force touch panel so as to improve an effect of force touch experience of a user.

### BRIEF DESCRIPTION OF THE DRAWINGS

The features and technical contents of the present invention will be better understood by referring to the following detailed description and drawings of the present invention. However, the drawings are provided for the purpose of reference and illustration and are not intended to limit the scope of the present invention.

In the drawing:

FIG. 1 is a schematic view illustrating a structure of a conventional force sensor;

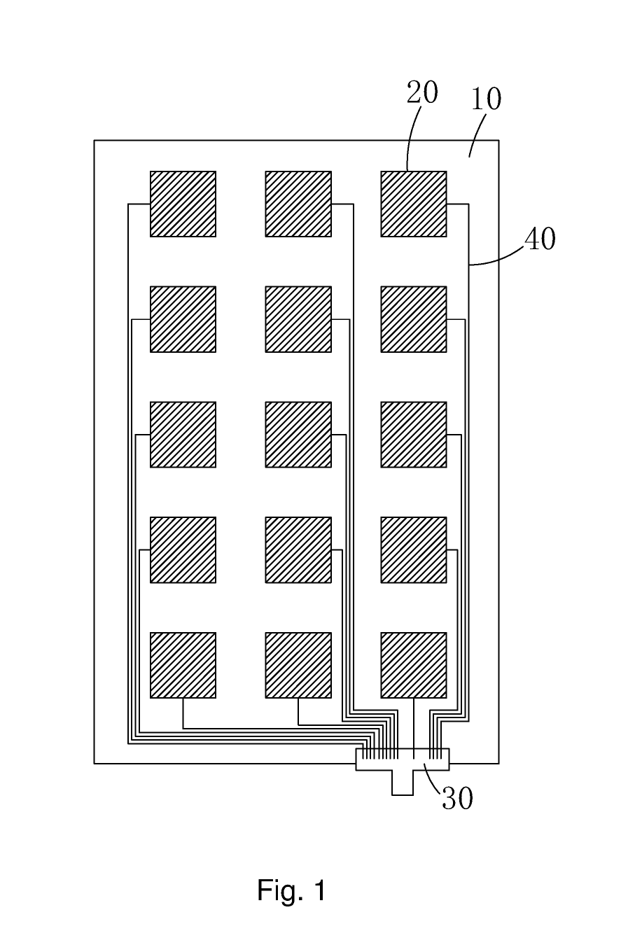

FIG. 2 is a schematic view illustrating a structure of a force sensor according to a first embodiment of the present invention;

FIG. 3 is a schematic view illustrating a structure of a force sensor according to a second embodiment of the present invention; and

FIG. 4 is a schematic view illustrating a structure of a force sensor according to a third embodiment of the present invention.

### DETAILED DESCRIPTION OF THE PREFERRED EMBODIMENTS

To further expound the technical solution adopted in the present invention and the advantages thereof, a detailed description is given to a preferred embodiment of the present invention with reference to the attached drawings.

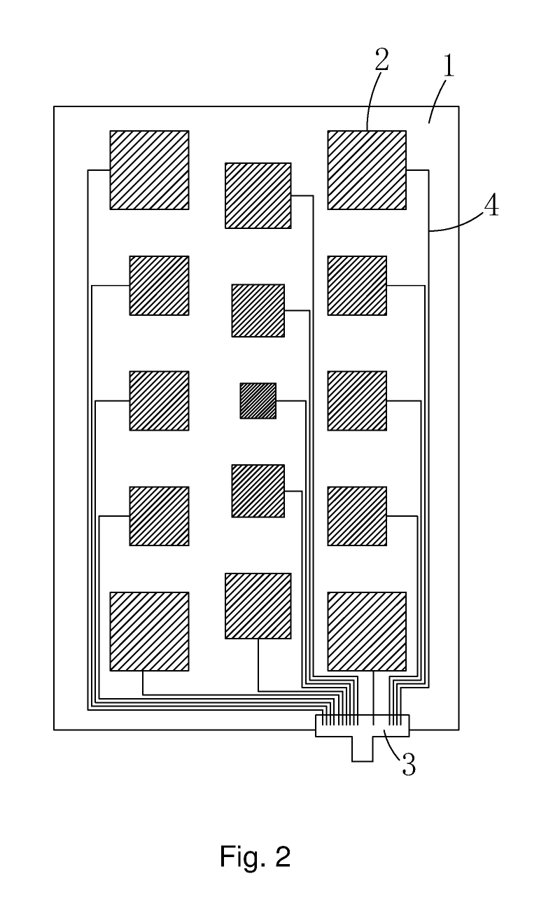

Referring to FIGS. 2-4, the present invention provides a force sensor, which comprises: a backing 1, a plurality of sensor units 2 arranged on the backing 1, a plurality of conductive lines 4 arranged on the backing 1 and respectively corresponding to the plurality of sensor units 2, and a circuit board 3 arranged at one side of the backing 1.

The sensor units 2 are connected, via the conductive lines 4 corresponding thereto, to the circuit board 3 in order to transmit a force signal detected thereby to the circuit board 3.

The plurality of sensor units 2 is arranged in a diverging form from a central position of the backing 1 toward a periphery of the backing 1.

Among the plurality of sensor units 2, the sensor unit 2 that is located at the central position has a smallest surface area and surface areas of the sensor units 2 are increased with the distances thereof from the central position of the backing 1.

Specifically, a process of force detection conducted with the force sensor is as follows. When an external force presses down the force touch panel, change of a gap between the force sensor and a corresponding detection electrode may occur, resulting in a variation of capacitance between the force sensor and the corresponding detection electrode so as to allow the sensor units 2 to detect the variation of capacitance. The sensor units 2 transmits the variation of capacitance through the conductive lines 4 corresponding thereto to the circuit board 3 so as to obtain a result of force detection and thus achieve a detection of force touch. When external forces of the same magnitude are applied to press down the central position and the periphery of the force touch panel, due to the sensor units 2 being arranged in a diverging form from the central position of the backing 1 toward the periphery of the backing 1 and the surface areas thereof being increased from the central position of the backing 1 toward the periphery of the backing plate 1, a difference in force variation resulting from different amounts of deformation between the center and the periphery caused by retention achieved with a module frame of the force touch panel can be compensated and eliminated so that force variations detected by the sensor unit 2 at the center of the backing 1 and the sensor units 2 at the periphery may be kept substantially consistent thereby ensuring consistent detection sensitivity through various areas of a surface of the force sensor and thus improving an effect of force touch experience of a user.

Specifically, the plurality of sensor units 2 and the plurality of conductive lines 4 may be formed with a manufacturing process as follows. A conductive layer is deposited on the backing 1 and one photolithographic process is applied to conduct patterning of the conductive layer so as to simultaneously form the plurality of sensor units 2 and the plurality of conductive lines 4 arranged on the backing 1. Such a process provides relatively high precession of the pattern so formed, but the process is relatively complicated.

Optionally, the plurality of sensor units 2 and the plurality of conductive lines 4 may alternatively be formed with a manufacturing process as follows. A screen printing process is used to have the plurality of sensor units 2 and the plurality of conductive lines 4 directly printed on the backing 1 based on predetermined shapes. Such a process shows relatively low precision, but the process is relatively simple.

Optionally, referring to FIG. 2, in a first embodiment of the present invention, the sensor units 2 have a shape of square.

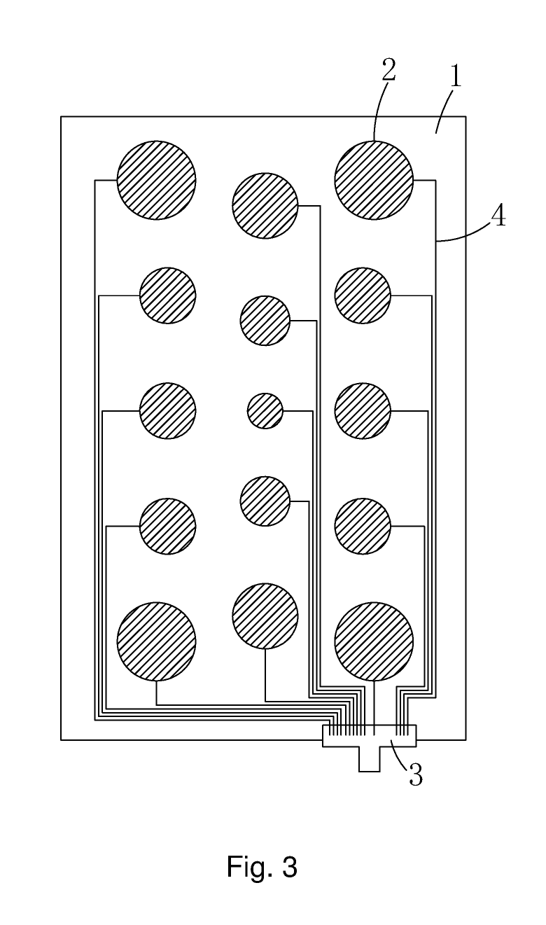

Optionally, referring to FIG. 3, in a second embodiment of the present invention, the sensor units 2 have a shape of circle. Due to a circle having the greater area among shapes having the same perimeter, the areas of the sensor units 2 may be increased in this case.

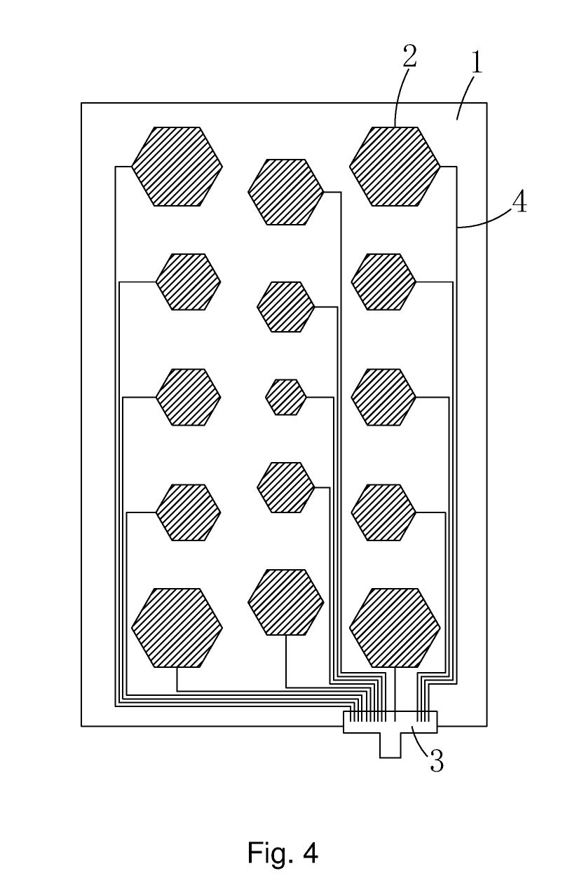

Optionally, referring to FIG. 4, in a third embodiment of the present invention, the sensor units 2 have a shape of hexagon. In a case where the backing 1 is close to a square, hexagonal sensor units 2, when arranged on the periphery of the backing 1, would allow boundaries of the sensor units 2 to be arranged in a neat and regular form and also helps increase utilization of the surface of the force sensor.

Further, the sensor units 2 may be alternatively designed in other shapes.

Specifically, the backing 1 comprises a flexible polymer film.

Preferably, the flexible polymer film is a polyethylene terephthalate (PET) film.

Specifically, the sensor units 2 and the conductive lines 4 are formed of a material comprising silver (Ag) or indium tin oxides (ITO).

Specifically, the circuit board 3 is a flexible circuit board.

Based on the same inventive idea, the present invention also provides a force touch panel that comprises the above-described force sensor in order to ensure consistent response sensitivity through various areas of a surface of the force touch panel and thus improving an effect of force touch experience of a user. Repeated description for the force sensor will be omitted herein.

In summary, the present invention provides a force sensor, which comprises a backing, a plurality of sensor units arranged on the backing, a plurality of conductive lines arranged on the backing and respectively corresponding to the plurality of sensor units, and a circuit board arranged at one side of the backing. Positions of the plurality of sensor units on the backing are arranged in a diverging form from a central position of the backing toward a periphery of the backing; and surface areas of the sensor units are arranged to be increased from a central position of the backing toward the periphery of the backing, so that in a condition where forces of the same magnitude are applied thereto, the sensor unit at the central position of the backing of the force sensor and the sensor units at a periphery of the backing would detect substantially the same amount of force variation, whereby, compared to the prior art, it is possible to ensure consistent detection sensitivity through various areas of the surface of the force sensor and improve an effect of force touch experience of a user. The present invention provides a force touch panel, which ensures consistent response sensitivity through various areas of the force touch panel so as to improve an effect of force touch experience of a user.

Based on the description given above, those having ordinary skills of the art may easily contemplate various changes and modifications of the technical solution and technical ideas of the present invention and all these changes and modifications are considered within the protection scope of right for the present invention as defined in the appended claims.

What is claimed is:

1. A force sensor, comprising: a backing, a plurality of sensor units arranged on the backing, a plurality of conductive lines arranged on the backing and respectively corresponding to the plurality of sensor units, and a circuit board arranged at one side of the backing;
wherein the sensor units are connected, through the conductive lines corresponding thereto, to the circuit board;
the plurality of sensor units are arranged in a diverging form from a central position of the backing toward a periphery of the backing; and
among the plurality of sensor units, the sensor unit located at the central position of the backing has a smallest surface area and surface areas of the remaining sensor units are increased with distances thereof from the central position of the backing.

2. The force sensor as claimed in claim 1, wherein the sensor units have a shape of one of square, circle, and regular hexagon.

3. The force sensor as claimed in claim 1, wherein the backing comprises a flexible polymer film.

4. The force sensor as claimed in claim 1, wherein the sensor units and the conductive lines are formed of a material comprising silver or indium tin oxides.

5. The force sensor as claimed in claim 1, wherein the circuit board is a flexible circuit board.

6. A force touch panel, comprising a force sensor;
wherein the force sensor comprises a backing, a plurality of sensor units arranged on the backing, a plurality of conductive lines arranged on the backing and respectively corresponding to the plurality of sensor units, and a circuit board arranged at one side of the backing;
the sensor units are connected, through the conductive lines corresponding thereto, to the circuit board;
the plurality of sensor units are arranged in a diverging form from a central position of the backing toward a periphery of the backing; and
among the plurality of sensor units, the sensor unit located at the central position of the backing has a smallest surface area and surface areas of the remaining sensor units are increased with distances thereof from the central position of the backing.

7. The force touch panel as claimed in claim 6, wherein the sensor units have a shape of one of square, circle, and regular hexagon.

8. The force touch panel as claimed in claim 6, wherein the backing comprises a flexible polymer film.

9. The force touch panel as claimed in claim 6, wherein the sensor units and the conductive lines are formed of a material comprising silver or indium tin oxides.

10. The force touch panel as claimed in claim 6, wherein the circuit board is a flexible circuit board.

11. A force sensor, comprising: a backing, a plurality of sensor units arranged on the backing, a plurality of conductive lines arranged on the backing and respectively corresponding to the plurality of sensor units, and a circuit board arranged at one side of the backing;
wherein the sensor units are connected, through the conductive lines corresponding thereto, to the circuit board;
the plurality of sensor units are arranged in a diverging form from a central position of the backing toward a periphery of the backing; and
among the plurality of sensor units, the sensor unit located at the central position of the backing has a smallest surface area and surface areas of the remaining sensor units are increased with distances thereof from the central position of the backing;
wherein the sensor units have a shape of one of square, circle, and regular hexagon; and
wherein the backing comprises a flexible polymer film.

12. The force sensor as claimed in claim 11, wherein the sensor units and the conductive lines are formed of a material comprising silver or indium tin oxides.

13. The force sensor as claimed in claim 11, wherein the circuit board is a flexible circuit board.
